(19) United States
(12) Patent Application Publication
(10) Pub. No.: US 2006/0022456 A1
(43) Pub. Date: Feb. 2, 2006

(54) Transition adapter for electrical conduit

(76) Inventors: Eric G. Hull, Madison, OH (US); Gregory D. Turcovsky, Mentor, OH (US); Dennis P. Revlock SR., Medina, OH (US)

Correspondence Address: STEPHEN D. SCANLON, JONES DAY, 901 LAKESIDE AVENUE, CLEVELAND, OH, 44114, US

(21) Appl. No.: 10/903,196

(22) Filed: Jul. 30, 2004

(51) Int. Cl. F16L 43/00

(52) U.S. Cl. 285/179

(57) ABSTRACT

A transition adapter for connecting together ENT tubing and threaded conduit has an ENT connector socket on one end portion thereof and a threaded socket on an opposite end portion thereof.

### BACKGROUND

This application relates to the art of electrical fittings and, more particularly, to an electrical fitting in the form of a transition adapter for connecting together an ENT tube and an externally threaded end portion of a pipe. The application particularly concerns stub down adapters and will be described with specific reference thereto. However, it will be appreciated that certain features of the fitting may be used with other types of adapters.

### SUMMARY

A fitting for connecting ENT conduit with an externally threaded end portion of a pipe has an ENT socket on one end portion and a threaded socket on its opposite end portion.

The fitting may be a straight through fitting for connecting ENT conduit and threaded pipe coaxially, or may be a 90° fitting for connecting ENT tubing and threaded pipe perpendicular to one another.

A mounting flange extends outwardly from the fitting at the end portion thereof that has the threaded socket therein.

### BRIEF DESCRIPTION OF THE DRAWING

FIG. 1 is a perspective illustration of a fitting in accordance with the present application;

FIG. 2 is another perspective illustration of the fitting;

FIG. 3 is still another perspective illustration of the fitting;

FIG. 4 is a top plan view thereof;

FIG. 5 is a bottom view thereof;

FIG. 6 is a side elevational view thereof;

FIG. 7. is another side elevational view thereof;

FIG. 8 is a cross-sectional elevational view taken generally on line 8-8 of FIG. 7;

FIG. 9 is a perspective illustration of another embodiment;

FIG. 10 is another perspective illustration thereof;

FIG. 11 is a side elevational view thereof;

FIG. 12 is a top plan view thereof;

FIG. 13 is a bottom view thereof;

FIG. 14 is an end elevational view thereof;

FIG. 15 is an end view of the end opposite from FIG. 14;

FIG. 16 is a partial cross-sectional elevational view;

FIG. 17 is a cross-sectional elevational view taken generally on line 17-17 of FIG. 14; and

FIG. 18 is a cross-sectional elevational view showing an externally threaded end portion of a pipe and an ENT tube received in the sockets in the fitting of FIGS. 1-8.

### DESCRIPTION OF EMBODIMENTS

In this application, ENT is an acronym for electrical nonmetallic tubing of the type formed by a flexible corrugated tube that is made of plastic material such as PVC.

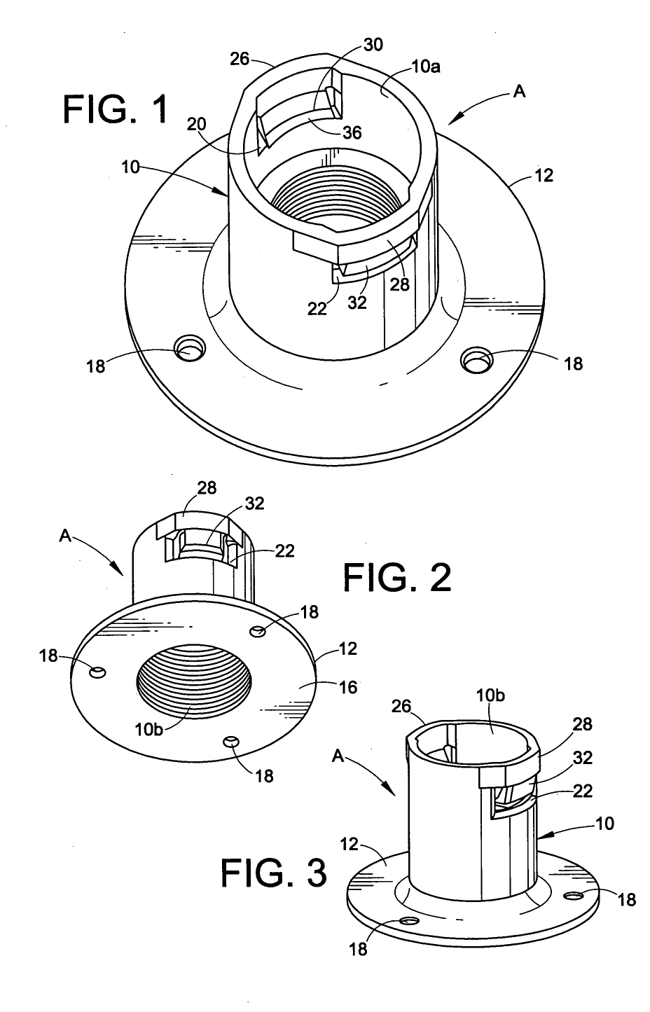

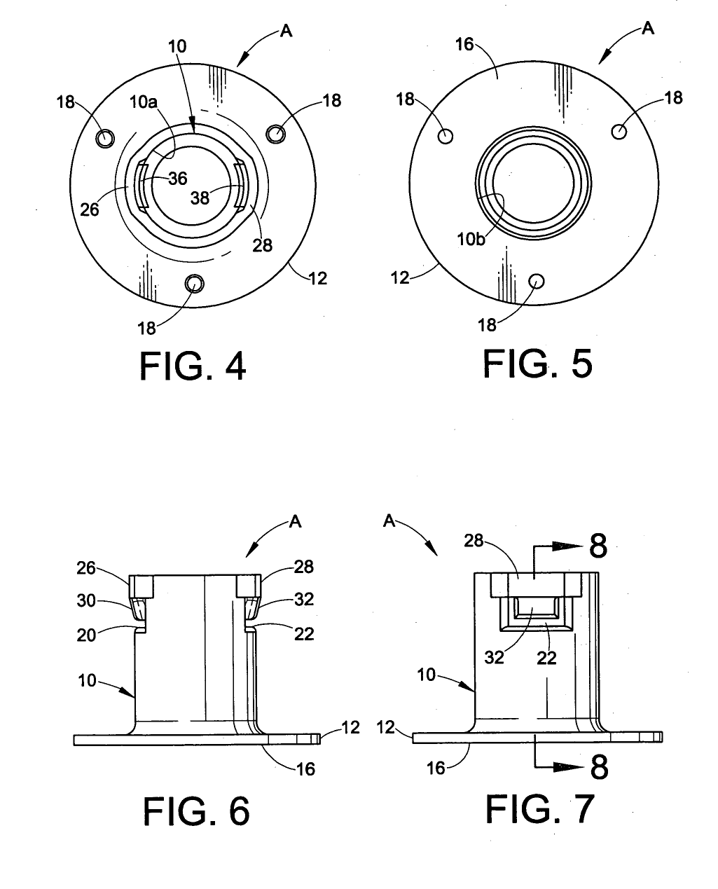

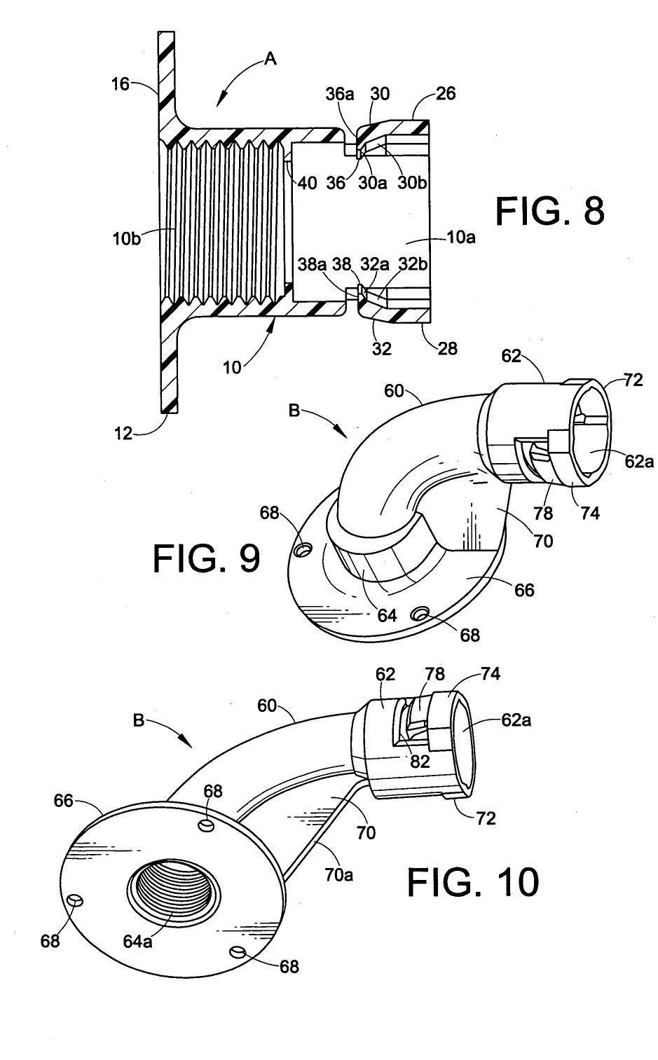

Referring now to the drawings, wherein the showings are for purposes of illustrating representative embodiments only and not for purposes of limiting same, FIGS. 1-8 show a tubular fitting A that is molded in one-piece of plastic material.

Fitting A has a generally cylindrical body portion 10 with ENT and threaded connectors at opposite end portions thereof in the form of an ENT socket 10a and a threaded socket 10b. A flat circular mounting flange 12 extends outwardly from the end of body portion 10 in which threaded socket 10b is formed. Mounting flange 12 has a flat bottom surface 16 that is positionable against a flat support surface, and has three equidistantly-spaced fastener receiving holes 18 for receiving fasteners to attach fitting A to the support surface.

Generally cylindrical body portion 10 has a pair of openings 20, 22 formed therein generally midway of the length of ENT socket 10a. Generally cylindrical body portion 10 has arcuate latch finger supports 26, 28 that are located opposite one another and bulge outwardly adjacent the ENT socket end of cylindrical body portion 10.

Opposite latch fingers 30, 32 project from latch finger supports 26, 28 into openings 20, 22 so that the openings are generally U-shaped around the latch fingers. Latch fingers 30, 32 have latch finger terminal end portions 36, 38 that project inwardly of the inner cylindrical surface of ENT socket 10a. Latch finger end portions 36, 38 are receivable in an external circumferential groove in an ENT tube that is receivable within ENT socket 10a.

Latch finger supports 26, 28 space the pivot point of latch fingers 30, 32 outwardly from the outer surface of an ENT tube that is received within socket 10a to provide enhanced flexibility of the latch fingers, and to provide camming action that tends to bend the latch fingers inwardly toward the longitudinal axis of the ENT socket when a force is applied in a direction that tends to remove the ENT tube from the socket.

An inwardly extending circumferential divider 40 is provided within generally cylindrical body portion 10 approximately midway between the opposite ends of the fitting. The end of an ENT tube that is received in ENT socket 10a normally engages divider 40.

Latch fingers 30, 32 have inner sloping surfaces 30a, 30b, 32a, 32b that are engaged by an ENT tube as it is inserted into ENT socket 10a for camming latch fingers 30, 32 outwardly so that the corrugated ENT tube can ratchet past latch finger end portions 36, 38. When the end of the corrugated ENT tube bottoms out against divider 40, latch finger end portions 36, 38 are received in an external circumferential groove in the ENT tube. Generally radial end surfaces 36a, 38a on latch finger end portions 36, 38 then are engageable with a generally radial groove sidewall on the ENT tube when a force is applied in a direction to remove the ENT tube from socket 10a. This causes the fingers to bend generally radially inwardly and more securely hold the ENT tube against removal from the socket.

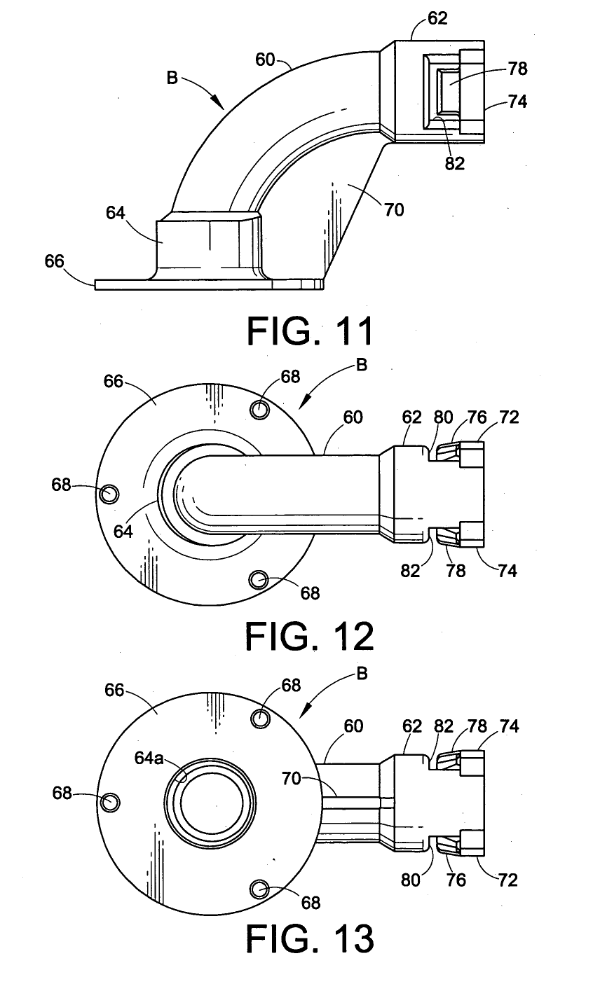

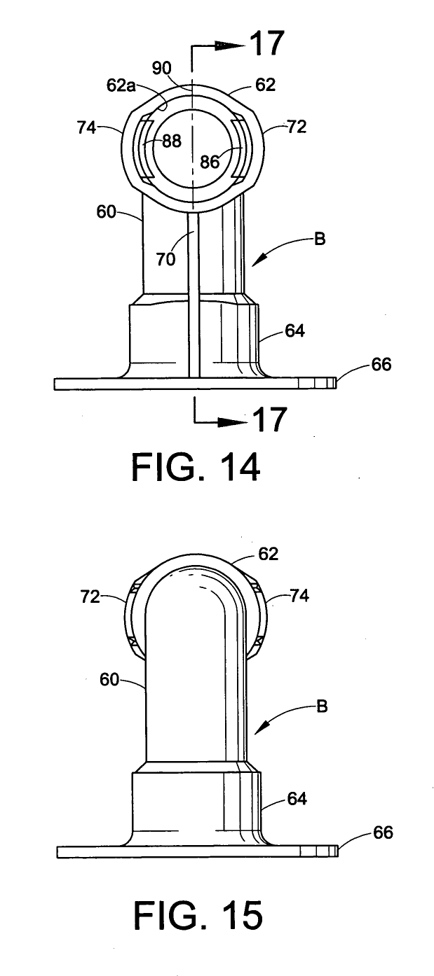

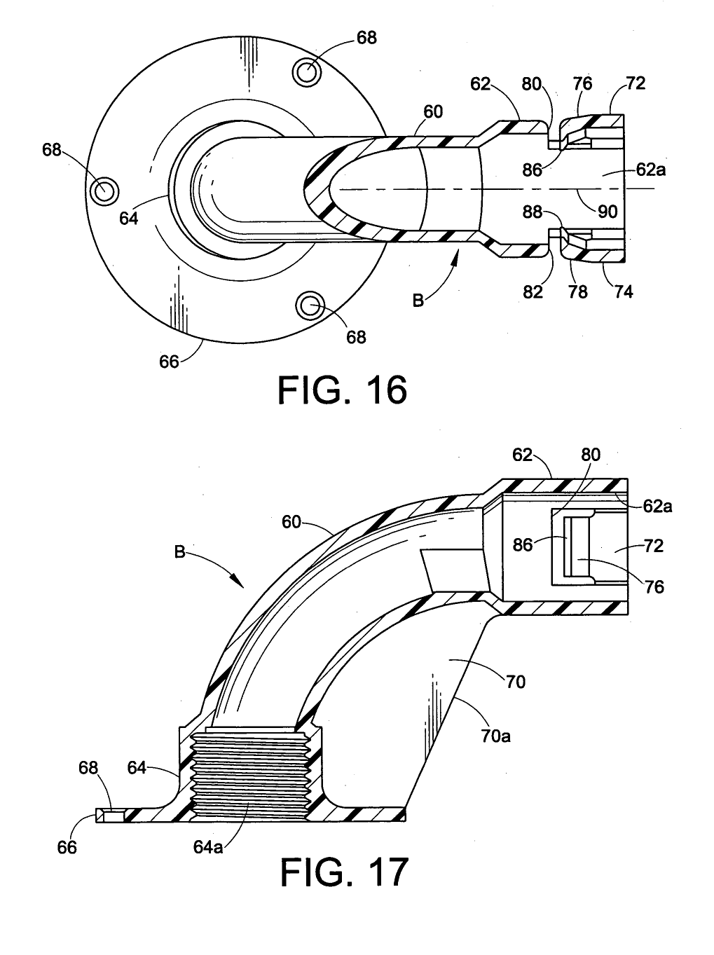

FIGS. 9-17 show another embodiment in the form of a tubular 90° fitting B having a curved tubular portion 60 with ENT and threaded connectors 62, 64 at opposite end portions thereof. ENT connector 62 has a generally cylindrical socket 62a for receiving an end portion of a corrugated ENT tube. Threaded connector 64 has a threaded socket 64a therein for receiving an externally threaded end portion of an electrical conduit. Sockets 62a and 64a extend generally perpendicular to one another at opposite ends of tubular portion 60.

A flat circular mounting flange 66 extends outwardly from fitting B at the threaded connector end thereof. Three equidistantly-spaced fastener receiving holes 68 are provided in mounting flange 66 for receiving fasteners to attach flange 66 to a flat support surface.

A reinforcing web 70 extends between mounting flange 66 and tubular portion 60 to reinforce tubular portion 60 against bending or breakage. Web 70 extends the full length of curved tubular portion 60 and along threaded connector end portion 64, but does not extend along ENT connector end portion 62. ENT connector end portion 62 is spaced outwardly from the outer periphery of mounting flange 66, and web 70 has an inclined leading edge 70a that is inclined upwardly and outwardly from the outer periphery of mounting flange 66 toward ENT connector 62.

Arcuate latch finger supports 72, 74 bulge outwardly from cylindrical ENT connector portion 62 and have latch fingers 76, 78 extending therefrom into opposite openings 80, 82 in the wall of connector portion 62. Latch fingers 76, 78 have latch finger end portions 86, 88 that are receivable in an external circumferential groove in an end portion of an ENT tube. Latch fingers 76, 78 are located on opposite sides of a plane 90 that bisects fitting B. Latch fingers 76, 78 on fitting B have cam surfaces and radial surfaces as described with reference to items 30a, 30b, 32a, 32b, 36a, 38a on latch fingers 30, 32 of fitting A.

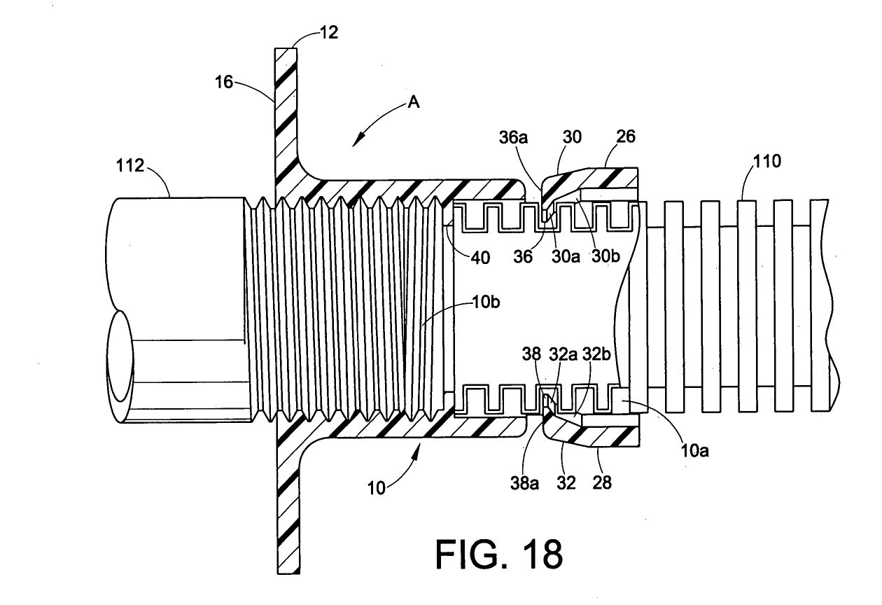

FIG. 18 shows an end portion of a corrugated ENT tube 110 received in socket 10a and a pipe 112 of metal or plastic having an externally threaded end portion received in socket 10b. ENT tubes and externally threaded end portions of pipes are receivable in the same manner in sockets 62a and 64a of fitting B.

ENT sockets 10a, 62a are sized for receiving either one-half inch, three-quarter inch or one inch trade size ENT tubing. One-half inch trade size ENT tubing has an outside diameter of 0.832-0.848 inches. Three-quarter inch trade size ENT tubing has an outside diameter of 1.040-1.060 inches. One inch trade size ENT tubing has an outside diameter of 1.305-1.325 inches.

Threaded sockets 10b, 64a are sized for receiving either one-half inch, three-quarter inch or one inch threaded pipe. The threaded sockets may have any common type of pipe thread including, but not necessarily limited to, NPT—National Pipe Thread or National Pipe Tapered or American Standard Taper Pipe Thread; UNC—Unified National Coarse; UNF—Unified National Fine; UNEF—Unified National Extra Fine; NPS—National Pipe Straight; NPTF—Dryseal American Standard Taper Pipe Thread; NPSF—Drysteal American Fuel Internal Straight Pipe Thread; NPSI—Dryseal American Intermediate Internal Straight Pipe Thread; and NPSM—American Standard Straight Mechanical Pipe Thread. Obviously, various metric pipe threads also may be used.

Although the fittings can be configured to transition between different sizes of ENT and externally threaded conduits, the fittings normally connect ENT and threaded conduits of the same size. Thus, a fitting having an ENT socket for receiving a one-half inch trade size ENT tube will have a threaded socket for receiving an externally threaded end portion on a one-half inch trade size pipe and so on.

Although the improvements of this application have been shown and described with reference to representative embodiments, it is obvious that alterations and modifications will occur to others skilled in the art upon the reading and understanding of this disclosure. Therefore, it is to be understood that the improvements may be practiced otherwise than as specifically described herein while remaining within the scope of the claims.

1. A transition adapter molded in one-piece of plastic material for connecting together an ENT tube and an externally threaded end portion of a pipe, said adapter having an ENT connector on one end portion thereof and a threaded connector on an opposite end portion thereof, said ENT connector having a peripheral wall and a generally cylindrical ENT socket that terminates in an ENT socket end, resilient latch fingers projecting into said ENT socket from said peripheral wall and having inwardly extending latch finger end portions receivable in an external circumferential groove of an ENT tube that is receivable in said ENT socket, said ENT socket peripheral wall having openings therethrough around said latch fingers, said latch fingers extending generally longitudinally of said ENT socket for bending movement generally radially of said ENT socket, said latch fingers projecting from said peripheral wall adjacent said ENT socket end and said latch finger end portions being spaced along said latch fingers in a direction away from said ENT socket end, said threaded connector having a threaded socket for threadably receiving an end portion of a pipe having an external thread thereon, and said threaded connector end portion terminating in an outwardly extending mounting flange having a generally flat bottom surface that forms the opposite end of said adapter that is opposite from said ENT socket end and is positionable against a generally flat support surface for supporting the adapter thereon.

2. The adapter of claim 1 wherein said ENT connector and said threaded connector are coaxial.

3. The adapter of claim 1 wherein said ENT connector and said threaded connector are at opposite end portions of a 90° elbow.

4. The adapter of claim 3 including a curved tubular portion extending between said ENT and threaded connectors, and a reinforcing web extending between said mounting flange and said curved tubular portion.

5. The adapter of claim 1 wherein said ENT socket is configured for receiving one-half inch, three-quarter inch or one inch trade size ENT tubing, and said threaded socket is configured for receiving an externally threaded end portion on a one-half inch, three-quarter inch or one inch trade size pipe.

6. The adapter of claim 1 wherein said adapter is a 90° elbow and said latch fingers are located on opposite sides of a plane that longitudinally bisects said adapter.

7. The adapter of claim 1 including an inwardly extending circumferential divider between said ENT socket and said threaded socket, said divider providing a stop for abutment by an end of an ENT tube that is received in said ENT socket.

8. The adapter of claim 1 wherein said peripheral wall of said ENT socket has generally opposite outwardly bulging latch finger supports and said latch fingers project from said latch finger supports along pivot points that are spaced outwardly from the outer surface of an ENT tube that is received in said ENT socket.

9. A transition adapter molded in one-piece of plastic material for connecting together an electrical nonmetallic tube and an externally threaded end portion of a pipe, said adapter having an electrical nonmetallic tubing connector on one end portion thereof and a threaded connector on an opposite end portion thereof, said electrical nonmetallic tubing connector having a peripheral wall and a generally cylindrical electrical nonmetallic tubing socket that terminates in an electrical nonmetallic tubing socket end, resilient latch fingers projecting into said electrical nonmetallic tubing socket from said peripheral wall and having inwardly extending latch finger end portions receivable in an external circumferential groove of an electrical nonmetallic tubing tube that is receivable in said electrical nonmetallic tubing socket, said electrical nonmetallic tubing socket peripheral wall having openings therethrough around said latch fingers, said latch fingers extending generally longitudinally of said electrical nonmetallic tubing socket for bending movement generally radially of said electrical nonmetallic tubing socket, said latch fingers projecting from said peripheral wall adjacent said electrical nonmetallic tubing socket end and said latch finger end portions being spaced along said latch fingers in a direction away from said electrical nonmetallic tubing socket end, said threaded connector having a threaded socket for threadably receiving an end portion of a pipe having an external thread thereon, and said threaded connector end portion terminating in an outwardly extending mounting flange having a generally flat bottom surface that forms the opposite end of said adapter that is opposite from said electrical nonmetallic tubing socket end and is positionable against a generally flat support surface for supporting the adapter thereon.

10. The adapter of claim 9 wherein said electrical nonmetallic tubing connector and said threaded connector are coaxial.

11. The adapter of claim 1 wherein said connector and said threaded connector are at opposite end portions of a 90° elbow.

12. The adapter of claim 11 including a curved tubular portion extending between said electrical nonmetallic tubing and threaded connectors, and a reinforcing web extending between said mounting flange and said curved tubular portion.

13. The adapter of claim 9 wherein said electrical nonmetallic tubing socket is configured for receiving one-half inch, three-quarter inch or one inch electrical nonmetallic tubing, and said threaded socket is configured for receiving an externally threaded end portion on a one-half inch, three-quarter inch or one inch pipe.

14. The adapter of claim 9 wherein said adapter is a 90° elbow and said latch fingers are located on opposite sides of a plane that longitudinally bisects said adapter.

15. The adapter of claim 9 including an inwardly extending circumferential divider between said electrical nonmetallic tubing socket and said threaded socket, said divider providing a stop for abutment by an end of an electrical nonmetallic tube that is secured in said electrical nonmetallic tubing socket.

16. The adapter of claim 9 wherein said peripheral wall of said electrical nonmetallic tubing socket has generally opposite outwardly bulging latch finger supports and said latch fingers project from said latch finger supports along pivot points that are spaced outwardly from the outer surface of an electrical nonmetallic tube that is received in said electrical nonmetallic tubing socket.
